(19) United States
(12) Patent Application Publication
(10) Pub. No.: US 2024/0372641 A1
(43) Pub. Date: Nov. 7, 2024

(54) Physical Layer Security

(71) Applicants: Brigham Young University, Provo, UT (US); Universidade de Coimbra, Coimbra (PT)

(72) Inventors: Willie Harrison, Provo, UT (US); Marco Gomes, Coimbra (PT); Joao Paulo da Silva Vilela, Coimbra (PT); Thyago Sa Pinto, Coimbra (PT)

(21) Appl. No.: 18/765,079

(22) Filed: Jul. 5, 2024

Related U.S. Application Data
(63) Continuation of application No. 17/416,195, filed on Jun. 18, 2021.
(60) Provisional application No. 62/782,810, filed on Dec. 20, 2018.
(60) Provisional application No. 62/841,644, filed on May 1, 2019.

(51) Int. Cl. H04K 1/00; H04L 1/00; H04L 9/30

(52) U.S. Cl. CPC H04K 1/00; H04L 1/0041; H04L 1/0045; H04L 1/0056; H04L 9/304

(57) ABSTRACT

A method and system for physical layer security are disclosed. In one embodiment, a sender may encode a message word using a secrecy-code encoding, an error-propagation encoding, and an error-correction encoding. The sender may then transmit the encoded message word on a data transmission medium. An intended recipient may receive, on its channel on the data transmission medium, a word having errors from the noise on the intended recipient's channel, and may decode the received word using an error-correction decoder, an error-propagation decoder, and a secrecy-code decoder. Assuming that an eavesdropper's channel is noisier than the intended recipient's channel, the system may be tuned to correct all errors on the intended recipient's channel, but leave, on the eavesdropper's channel, errors that will be propagated and amplified into noise. In an alternate embodiment, a sender and an intended recipient may share a secret key and may use the shared secret key, or values generated by the shared secret key, to populate frozen bits in a polar coding scheme. Because the eavesdropper does not know the shared secret, the eavesdropper's application of successive cancellation decoding results in only noise. This embodiment works as long as the eavesdropper has some noise on its channel.

### CROSS REFERENCE TO RELATED APPLICATIONS

This application is a continuation of and claims priority to U.S. non-provisional application Ser. No. 17/416,195 filed on Jun. 18, 2021. U.S. non-provisional application Ser. No. 17/416,195 claims priority to PCT App. No. PCT/US2019/067533 filed on Dec. 19, 2019. PCT App. No. PCT/US2019/067533 claims priority to U.S. Provisional App. No. 62/782,810 filed on Dec. 20, 2018 and additionally claims priority to U.S. Provisional App. No. 62/841,644 filed on May 1, 2019. These applications are incorporated by reference in their respective entireties.

### GOVERNMENT LICENSE RIGHTS

This invention was made with government support under Grant Numbers 1460085 and 1761280 awarded by the National Science Foundation. The government has certain rights in the invention.

### BACKGROUND OF THE INVENTION

Data transmission is a ubiquitous part of life. Whether on wires, cables, fiber, wirelessly, or otherwise, large amounts of data are being transmitted 24/7. Although some data, if publicly known, would be innocuous, a significant amount of transmitted data is private and disclosure of such data could result in financial loss, embarrassment, or other negative consequences.

One problem is eavesdroppers. An eavesdropper is a person or piece of equipment that literally taps a physical wire or uses an antenna or other device to collect wireless signals from the air. In today's environment of Wi-Fi, cellular data transmission, wireless transmission, and other wireless communication technologies, it is difficult if not impossible to prevent eavesdropping. It is therefore important to protect the secrecy of transmitted data. Even if a third party is able to eavesdrop and collect transmitted data, no harm will result to the sender or intended recipient if the eavesdropper is unable to interpret the collected data. For example, if an eavesdropper does not have the necessary decryption key, encrypted data may appear to an eavesdropper as arbitrary and random noise, or as an unrecoverable transmitted message.

Although encryption schemes are often effective, many communication systems and devices do not implement or cannot implement encryption—at either the hardware or software level. Also, although some schemes have been proposed that may provide some level of data transmission secrecy if the noise characteristics of an eavesdropper's channel are known, these approaches do not address the far more common situation in which the noise characteristics of the eavesdropper's channel are unknown or are known only by estimation or assumption.

What is needed is an improved system and method, implemented at the physical layer, for protecting the secrecy of data transmissions.

### BRIEF SUMMARY OF THE INVENTION

A system for three-stage physical layer security may comprise—at a sender's computer, electronic device computing device, or other computing device-computer-readable instructions that, when executed, cause the sender's computer to: obtain a message word that the sender desires to send to an intended recipient; encode the message word with a secrecy code encoder; encode the output of the secrecy code encoder with an error propagation encoder; encode the output of the error propagation encoder with an error correction encoder; and transmit the output of the error correction encoder on a data transmission medium, e.g., a wireless network or connection.

The system for three-stage physical layer security may additionally comprise—at an intended recipient's computer, electronic device, or other computing device—computer-readable instructions that, when executed, cause the intended recipient's computer to: receive, on the intended recipient's channel on the data transmission medium, a word transmitted by the sender; decode the received word with an error correction decoder that corresponds to the sender's error correction encoder; decode the output of the error correction decoder with an error propagation decoder that corresponds to the sender's error propagation encoder; and decode the output of the error propagation decoder with a secrecy code decoder that corresponds to the sender's secrecy code encoder.

If an eavesdropper's channel on the data transmission medium is noisier than the intended recipient's channel, then the system for three-stage physical layer security may be tuned to result in practical information-theoretic security: the message received by the intended recipient is completely correct (no errors), but the message received by the eavesdropper is noise. Tuning may include, but is not limited to, adjusting the error correction level of the error correction encoder/decoder so that all errors on the intended recipient's channel are corrected, but all errors on the eavesdropper's channel are not corrected. Tuning may further include adjusting, in the secrecy code encoder/decoder, the rate of the length of a message word to the length of the corresponding encoded codeword. Tuning may further include adjusting the level of error propagation in the error propagation encoder/decoder.

In one embodiment, the system may be tuned based on assumptions or known information about the differences between the noise characteristics of the eavesdropper's channel and the noise characteristics of the intended recipient's channel. In one embodiment, the intended recipient may transmit, or otherwise provide, to the sender (the eavesdropper will also have receive this information) information about the noise characteristics of the intended recipient's channel, and the sender may adjust or tune the system based on such information.

In an alternate embodiment, a system for polar-code physical layer security may comprise—at a sender's computer, electronic device computing device, or other computing device—computer-readable instructions that, when executed, cause the sender's computer to: obtain a message word that the sender desires to send to an intended recipient; obtain a secret that is shared with an intended recipient; interleave or multiplex the message word with the shared secret to generate a vector; multiply the vector by a generator matrix to output an encoded word; and transmit the encoded word on a data transmission medium, e.g., a wireless network or connection.

The system for polar-code physical layer security may comprise—at an intended recipient's computer, electronic device, or other computing device—computer-readable instructions that, when executed, cause the intended recipient's computer to: receive, on the intended recipient's channel on the data transmission medium, a word transmitted by the sender; obtain the shared secret (shared between the sender and the intended recipient); use the shared secret to apply a successive cancellation decoder to generate a vector; and remove the interleave/multiplexed bits from the vector, thereby outputting the message word.

Because the sender and intended recipient use a shared secret to generate the same values for the frozen bits, the intended recipient decodes the word received on its channel to the message word that the sender desired to send, but the eavesdropper obtains only noise because the eavesdropper does not know the shared secret that is necessary for successive cancellation decoding.

By using a secret that is shared between the sender and the intended recipient, but that is not known by the eavesdropper, the system for polar-code physical layer security results in secrecy (the intended recipient obtains the message word that the sender desired to send, but the eavesdropper obtains only noise) even if the intended recipient's channel is noisier than the eavesdropper's channel. The only necessary condition is that the eavesdropper's channel has at least some noise.

Methods for the disclosed systems are also disclosed.

### BRIEF DESCRIPTION OF THE DRAWINGS

FIG. 1 illustrates a conceptual view of an exemplary environment for use of the systems and methods disclosed herein.

FIG. 2 illustrates a conceptual view of a system for three-stage physical layer security.

FIG. 3 illustrates an exemplary wiretap table that may be used for three-stage physical layer security.

FIG. 4 illustrates a flowchart for an exemplary method for a sender to implement a three-stage physical layer security approach.

FIG. 5 illustrates a flowchart for an exemplary method for an intended recipient to implement a three-stage physical layer security approach.

FIG. 6 illustrates a conceptual view of a system for polar-code physical layer security.

FIG. 7 illustrates a flowchart for an exemplary method for a sender to implement a polar-code physical layer security approach.

FIG. 8 illustrates a flowchart for an exemplary method for an intended recipient to implement a polar-code physical layer security approach.

### DETAILED DESCRIPTION OF THE INVENTION

This application claims priority to U.S. Provisional Application No. 62/782,810, titled “Three-stage Coding Approach to Physical-layer Security,” and filed on Dec. 20, 2018, and which is incorporated herein by reference in its entirety. This Application also claims priority to U.S. Provisional Application No. 62/841,644, titled “Polar-coding for Physical-layer Security without Knowledge of the Eavesdropper's Channel,” and filed on May 1, 2019, and which is incorporated herein by reference in its entirety. This Application also claims priority to Portuguese provisional number [number not yet received from Portugal INPI as of filing date] filed on Dec. 16, 2019.

A system and method are disclosed for improved physical layer security.

Table of Reference Numbers from Drawings:

The following table is for convenience only, and should not be construed to supersede any potentially inconsistent disclosure herein.

Table of Reference Numbers from Drawings:

| Reference | |
|---|---|
| Number | Description |
| 110 | Alice (message sender) |
| 112 | Alice’s implementation of stage 1 encoder |
| 114 | Alice’s implementation of stage 2 encoder |
| 116 | Alice’s implementation of stage 3 encoder |
| 120 | Bob (intended recipient) |
| 121 | Bob’s channel |
| 122 | Bob’s implementation of stage 3 decoder |
| 124 | Bob’s implementation of stage 2 decoder |
| 126 | Bob’s implementation of stage 1 decoder |
| 130 | Eve (eavesdropper) |
| 131 | Eve’s channel |
| 132 | Eve’s implementation of stage 3 decoder |
| 134 | Eve’s implementation of stage 2 decoder |
| 136 | Eve’s implementation of stage 1 decoder |
| 200 | system for three-stage security |
| 210 | Bob’s house |
| 220 | Eve’s house |
| 230 | wireless communication signal from Alice |
| 300 | wiretap table |
| 310 | message word column |
| 312 | message word |
| 314 | message word |
| 316 | message word |
| 318 | message word |
| 350 | row of codewords for corresponding message word |
| 351 | codeword value |
| 360 | row of codewords for corresponding message word |
| 370 | row of codewords for corresponding message word |
| 380 | row of codewords for corresponding message word |
| 390 | column corresponding to random number |
| 400 | flowchart illustrating how Alice applies encoders to |
| | message word and transmits |
| 410 | step in flowchart 400 |
| 420 | step in flowchart 400 |
| 430 | step in flowchart 400 |
| 440 | step in flowchart 400 |
| 450 | step in flowchart 400 |
| 460 | step in flowchart 400 |
| 500 | flowchart illustrating how Bob receives encoded |
| | transmitted message and applies decoders |
| 510 | step in flowchart 500 |
| 520 | step in flowchart 500 |
| 530 | step in flowchart 500 |
| 540 | step in flowchart 500 |
| 550 | step in flowchart 500 |
| 600 | system for polar coding security |
| 610 | Alice (sender) |
| 612 | Alice’s implementation of V-generation module |
| 614 | Alice’s implementation of successive cancellation module |
| 620 | Bob (intended recipient) |
| 622 | Bob’s implementation of successive cancellation decoder |
| 624 | Bob’s implementation of V-decoder |
| 630 | Eve (intended recipient) |
| 632 | Eve’s implementation of successive cancellation decoder |
| 634 | Eve’s implementation of V-decoder |
| 650 | shared secret |
| 700 | flowchart illustrating how Alice prepares a message for |
| | transmission in the polar coding embodiment |
| 710 | step in flowchart 700 |
| 720 | step in flowchart 700 |
| 730 | step in flowchart 700 |
| 740 | step in flowchart 700 |
| 800 | flowchart illustrating how Bob receives and decodes a |
| | message from Alice in the polar coding embodiment |
| 810 | step in flowchart 800 |
| 820 | step in flowchart 800 |
| 830 | step in flowchart 800 |
| 840 | step in flowchart 800 |

### Three-stage Security

In one embodiment, a method for physical-layer security may comprise a three-stage coding scheme that exploits differences between the noise characteristics of an eavesdropper's channel and the noise characteristics of an intended recipient's channels. In the exemplary embodiments described herein, a sender (“Sender” or “Alice”) may desire to transmit data to an intended recipient (“Intended Recipient” or “Bob”), and an eavesdropper (“Eavesdropper” or “Eve”) may have access to the signals transmitted between Alice and Bob, and a means for collecting such signals. The hardware and software used by Alice, Bob, and Eve may be any of the numerous data transmission and reception devices and technologies known in the art. For example, Alice may be a WiFi router in Bob's home, Bob may be a laptop in the living room of his home, and Eve may be a laptop or other device having a wireless collection antenna located in a neighboring house or on an adjacent street.

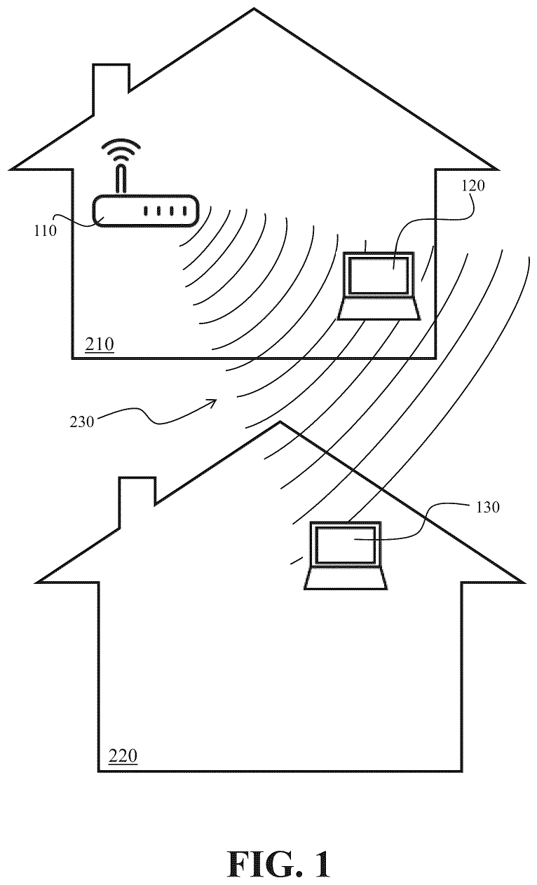

FIG. 1 shows an exemplary environment in which the three-stage security approach may be applicable. As shown in FIG. 1, Alice may be a WiFi router 110 in Bob's house 210, Bob may be a laptop 120 in his house 210, and Eve may be a laptop 130 in Eve's house 220. Eve's house 220 and Bob's house 210 may be neighboring houses. Wireless signal 230 may be the wireless signal emitted from Alice 110, and as shown in FIG. 1, may be available for reception by both Bob 120 and Alice 130.

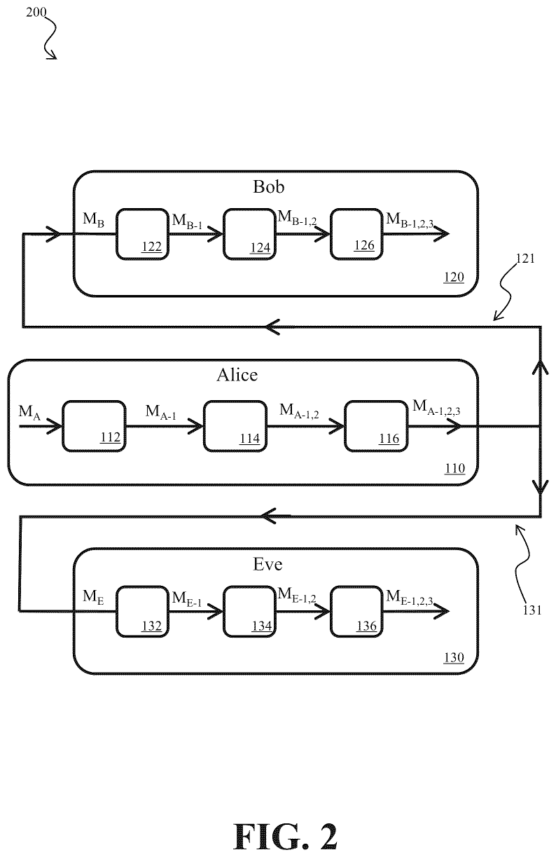

FIG. 2 illustrates a system 200 for three-stage security. As shown in FIG. 2, Alice 110 may determine to transmit a message word M_{A} to Bob 120. As described in detail below, Alice 110 may apply a three-stage coding scheme to M_{A}, and the output may be encoded as message word M_{A-1,2,3}. Stage one 112 may comprise a secrecy encoding. Stage two 114 may comprise an error propagation encoding. And stage three 116 may comprise an error correction encoding. When Alice 110 transmits M_{A-1,2,3}, Bob 120 receives transmitted message word M_{B} (Alice's transmitted message as received by Bob) on his channel, and Eve 130 receives message word M_{E} (Alice 110's transmitted message as received by Eve 130) on Eve 130's channel. Bob 120 and Eve 130 may then use identical decoders (or decoders that produce identical output)—to decode M_{B} and M_{E}, respectively. These three decoders may comprise an error correction decoder to decode Alice's stage-three error-correction encoding (122 for Bob; 132 for Eve), an error propagation decoder to decode Alice's stage-two error propagation encoding (124 for Bob; 134 for Eve), and a secrecy decoder to decode Alice's stage-one secrecy encoding (126 for Bob; 136 for Eve).

Although Bob 120 and Eve 130 use identical decoders, only Bob 120 is able to successfully obtain Alice 110's message M_{A}. As a result of differences in the noise characteristics between Bob 120's channel and Eve 130's channel, Eve 130 obtains only noise, i.e., is unable to produce a message that is correlated to M_{A}.

Under many circumstances, this three-stage scheme may approach practical information-theoretic security, i.e., complete secrecy whereby Bob 120's application of the three decoders 122, 124, and 126 outputs the actual message M_{A}, but Eve 130's application of the same three decoders 132, 134, and 136 outputs only noise.

The effectiveness of this three-stage approach depends on the noise characteristics of Eve's channel 131 and/or of Bob's channel 121. In some embodiments, Alice 110 may make assumptions about the noise characteristics of Bob's channel 121 or may rely on direct, indirect, or passive approaches to determine some or all noise characteristics of Bob's channel 121. It is assumed that Eve 130 and Alice 110 both have access to the same information about the noise characteristics of Bob's channel 121, and that neither party has any information that the other does not have. In other words, this three-stage approach does not depend on Alice 110's having information that is superior to Eve 130's information. Eve 130's knowledge of the noise characteristics of Bob's 121 channel does not compromise the effectiveness of the three-stage approach described herein. The only assumption that must hold for this three-stage approach is that Eve's channel 131 is noisier than Bob's channel 121. In some embodiments, as described below, it may even be sufficient that the noise on Eve's channel 131 is different from the noise on Bob's channel 121—even if Eve's channel 131 is not noisier than Bob's channel 121.

In some embodiments, Alice 110 may make and use assumptions about the noise characteristics on Eve's channel 131, or may use other information about the noise characteristics on Eve's channel 131. For example, if Alice 110 is a home WiFi router and Bob 120 is an authorized laptop inside the home, and Eve 130 is a neighbor attempting to sniff WiFi communications between Alice 110 and Bob 120, Alice 110 may make assumptions about the characteristics of noise on Eve's channel 131 relating to the distance from Alice 110 to Eve 130 (e.g., assuming that 130 is further from Alice 110 than Bob 120), or relating to the number and characteristics of obstructing between Alice 110 and Eve 130 (e.g., assuming that more walls, and possibly thicker walls of differing materials, obstruct WiFi signals from Alice 110 to Eve 130 than from Alice 110 to Bob 120). In one embodiment, the three-stage approach described herein may assume that Eve's channel 131 is a Gaussian channel, a fading channel, or another type of channel that models real-life broadcast channels.

Alice's stage-one encoder 112 may comprise application of a secrecy code. A secrecy code may also be referred to as a wiretap code. Exemplary secrecy codes include coset codes, polar-coding-based codes, invertible-extractor-based codes, or other secrecy codes known in the art. In general, a secrecy code comprises an encoder and associated decoder. A secrecy encoder maps a message word to a codeword that is longer than the input message word, and the corresponding secrecy decoder maps a codeword back to a message word.

In one explanatory example, a secrecy encoder may encode an input message word M as M_{EO} (encoder output). If M_{DI} (decoder input) has no errors relative to M_{EO} i.e., M_{DI}=M_{EO}, then the output M_{DO}=M (i.e., the output of the secrecy decoder is equivalent to the original message word). For example, if the secrecy encoder encodes message word M as M_{EO}, and M_{DI}=M_{EO}, then the secrecy decoder decodes M_{DI} to M_{DO}=M. The signature feature of a secrecy code is that a very low error rate results in very high uncertainty, i.e., very high noise. For example, in many secrecy code implementations, even one bit-error in M_{DI} relative to M_{EO} (i.e., M_{DI}≠M_{EO}) results in a completely (or highly) random/arbitrary output relative to the associated input M, i.e., M_{DO} is random relative to M. This randomness is not resolvable, even with infinite resources and computing time.

Returning to FIG. 2, the output of Alice 110's application of stage-one secrecy encoder 112 to M_{A} is referred to as M_{A-1}.

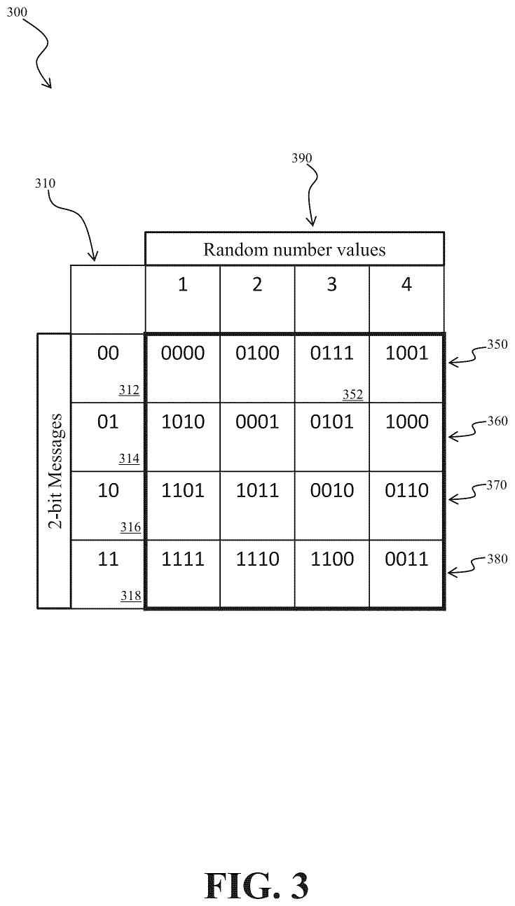

FIG. 3 shows an ultra-simplified exemplary wiretap table 300 that may be used at stage one to encode message words as wiretap codewords. Message words 312, 314, 316, and 318 in the left-most column 310 are encoded as one of the wiretap codewords to the right in the corresponding rows 350, 360, 370, and 380. For example, message word 312, which has a value of “00”, may be encoded as either of the values “0000,” “0100,” “0111,” or “1001” in row 350. Alice 110 may determine which of these four wiretap codewords to use by randomly selecting a number 1-4 and using the selected random number as an index to one of the four possible codewords for the message word. For example, to wiretap code the message word 312, the value of which is “00,” Alice 110 may randomly select a number from 1-4. If the random number is 3, Alice selects table location 352, the value of which is “0111,” as the codeword because “0111” is the codeword on the row 350 for the message word “00” and in the column for the random number 3.

As shown in FIG. 3, because wiretap coding arbitrarily/randomly assigns wiretap codewords to message words, one incorrect bit anywhere in a transmitted wiretap codeword results in random noise when the codeword is decoded. For example, in the example above in which the message word is “00,” the random number is 3, and the wiretap codeword is therefore “0111,” an error in the first bit location (“1111” instead of “0111”) would decode to the message word “11,” an error in the second bit location (“0011” instead of “0111”) would decode to the message word “11,” an error in the third bit location (“0101” instead of “0111”) would decode to the message word “01,” and an error in the fourth bit location (“0110” instead of “0111”) would decode to the message word “10.” A recipient is not able to guess the actual value of a message word from a partially erroneous codeword because the codeword-to-message word mapping is arbitrary.

It should be noted that the example shown in FIG. 3 and discussed above is extremely simplified. In a more practical example, the length of a message word may be much longer than two bits, and a single bit-error in the input to the decoder will result in an outputted message word that is completely unrelated to the original message word, i.e., the outputted message word is noise relative to the original message word. Because even one bit-error in a codeword results in a completely random (i.e., noisy) decoded message word, the secrecy decoder outputs noise for any input codeword that includes one or more bit errors.

A secrecy code may be tuned by increasing or decreasing the rate of the length of a message word to the length of the corresponding encoded codeword. As this rate decreases, the probability that a codeword will decode to noise increases. As this rate increases, the probability that a codeword will decode to the correct input message word increases. Note that the secrecy code shown in FIG. 3 is a representation of a possible wiretap code. Often, these codes are constructed so that the first row in the table forms a vector space, and the following rows consist of cosets of that vector space. The added structure allows for efficient encoding and decoding. This idea is commonly known as coset wiretap coding. Many implementations and variations of secrecy coding and wiretap coding are known in the art.

Alice's stage-two encoding 114 may comprise an error propagation encoding, e.g., a scrambler, interleaver, or hash function or other encoding algorithm in which at least one output bit is a function of two or more input bits. In general, and in many implementations, each output bit is a function of roughly half of the input bits.

In one embodiment using a scrambler error propagation encoding, stage-one encoded message M_{A-1} may be multiplied by a scrambling matrix (sometimes referred to as an S-box in cryptography), resulting in M_{A-1,2}.

In a second embodiment using an interleaver or permuter, Alice 110 and Bob 120 may select an interleaving (or re-ordering) pattern, possibly using a shared key. Without a shared key, a single interleaver, or series of interleavers with known interleaving patterns may be used (sometimes referred to as a P-box in cryptography), resulting in M_{A-1,2}.

In a third embodiment, a series of scramblers and interleavers may be used in any desired order to achieve the encoding, resulting in M_{A-1,2}.

In a fourth embodiment, a cryptographic hash function may be used to hash the input to produce the output M_{A-1,2}. This fourth embodiment may also make use of a secret key if available. Many implementations and variations of error-propagation coding are known in the art.

Because the input M_{A-1} to Alice 110's stage-two error propagation encoder is clean, i.e., contains no errors, the output M_{A-1,2} of Alice 110's stage-two error propagation encoder does not include propagated errors. Each bit of M_{A-1,2} (or at least one bit of the output) is a function of at least two bits, and likely many more bits, from the input M_{A-1}.

Alice's stage-three encoder 116 comprises implementing an error correcting code such as LDPC (low-density parity-check) code, BCH code, convolutional code, or other error correction coding known in the art. Other error correction mechanisms may include, but are not limited to, authenticated feedback, beamforming, and/or channel precoding matched to the intended recipient's channel characteristics. As with stage one and stage two, Both Bob 120 and Eve 130 are aware of all aspects and parameters of the stage-three error-correcting scheme.

In one embodiment, Bob 120 may provide to Alice 110 (and Eve 130 may also receive) feedback that Alice 110 may use to tune the stage-one, stage-two, and/or stage-three encoders. Any changes to the encoders or parameters, or any encoder tuning may be known to both Bob 120 and Eve 130. For example, at stage one 112, Alice 110 may change the type of secrecy code, or the length of input message words, or the length of output codewords, or any other adjustments, modifications, or tuning known in the art. At stage two 114, Alice 110 may change the type of error propagation code and/or any associated parameters. At stage three 116, Alice 110 may increase or decrease the level of error correction based on feedback from Bob 120 or for any other reason. Many adjustments, modifications, and/or tuning for all three stages are known in the art.

For example, if LDPC codes are used for error correction, Bob 120 may transmit to Alice 110 information about failed LDPC codewords, and Alice 110 may use this information to increase, decrease, or otherwise tune the LDPC encoding. Assuming that Eve's channel 131 is noisier than Bob's channel 121, the error correction level may be set high enough to correct all errors on Bob's channel 121, but low enough that it does not correct all errors on Eve's channel 131. In another embodiment, if differences between the noise characteristics of Bob's channel 121 and Eve's channel 131 are known or assumed, the error correction scheme may be tuned to ensure correction of all errors on Bob's channel 121 but not all errors on Eve's channel 131. The important feature of the error correction scheme is that it corrects all errors on Bob's channel 121 but does not correct all errors on Eve's channel 131. In some embodiments in which some error level may be acceptable to Bob 120, it may be acceptable to correct enough errors for Bob 120 so that the error level is low enough to be acceptable to Bob 120, and leave enough errors for Eve 130 to maintain a desired or acceptable level of secrecy.

When Alice 110 transmits M_{A-1,2,3}, Bob 120 receives M_{B} (M_{A-1,2,3} as received on Bob's channel 121) and Eve 130 receives M_{E} (M_{A-1,2,3} as received on Eve's channel 131). The transmission may be wireless, cable, wire, or any other communication transmission medium known in the art.

Bob 120 and Eve 130 each apply an identical stage-three decoder (122 for Bob; 132 for Eve), followed by an identical stage-two decoder (124 for Bob; 134 for Eve), followed by an identical stage-one decoder (126 for Bob; 136 for Eve).

Bob's stage-three decoder 122 and Eve's stage-three decoder 132 decode the error correcting encoding applied by Alice 110 at stage three 116. Because, as described herein above, the error correction scheme has been tuned or designed to correct all errors on Bob's channel 121 but not all errors on Eve's channel 131, the output M_{B-3} from Bob's application of the stage-three error-correction decoder 122 to M_{B} is errorless, i.e., M_{B-3}=M_{A-1,2}, but the output M_{E-3} from Eve's application of the stage-three error-correction 132 decoder to M_{E} is not errorless, i.e., M_{E-3}≠M_{A-1,2}.

The stage-two decoder is an inverse of the stage-two encoder, and takes as input the output of the stage-three decoder (for Bob 120, M_{B-3}=M_{A-1,2}; for Eve 130, M_{E-3}≠M_{A-1,2}). Because the error propagation encoder and the error propagation decoder both propagate input errors (output bits are a function of at least two input bits and often roughly half of the input bits), Eve's application of the stage-two decoder 134 propagates the errors in M_{E-3} in the output M_{E-3,2}. For Bob 120, however, because any errors in M_{B} were corrected at Bob's application of the stage-three decoder 122 and therefore M_{B-3}=M_{A-1,2}, Bob's application of the stage-two decoder 123, which is the inverse of the stage-two encoder 114, takes as input M_{B-3}=M_{A-1,2} and outputs M_{B-3,2}=M_{A-1}. M_{B-3,2} has no errors because the input M_{B-3} had no errors, and the stage-two decoder 124 therefore propagated no errors.

The stage-one decoder decodes the secrecy code that Alice 110 applied using the stage-one encoder 112. As explained herein above, using a secrecy encoder/decoder at stage one converts partial errors into complete noise, i.e., amplifies the noise effect of each bit-error. The noise resulting from bit-errors in a secrecy code scheme are unresolvable-even with infinite computing time and resources. Because for Bob 120 M_{B-3,2}=M_{A-1} and is therefore errorless, Bob's application of the stage-one decoder 126 takes as input M_{B-3,2} and outputs M_{B-3,2,1}=M_{A}. Because for Eve 130 M_{E-3,2}≠M_{A-1} and therefore includes errors, Eve's application of the stage-one decoder 136 takes as input M_{E-3,2} and outputs M_{E-3,2,1}≠M_{A}. Because of the effect of the secrecy code, M_{E-3,2,1} does not just have errors, but is highly noisy or completely noisy, e.g., arbitrary or random. A theoretical guarantee of the complete uncertainty in M_{E-3,2,1} is achievable if the ratio of the length of a stage-one message word to the length of the corresponding encoded codeword is sufficiently small relative to the bit-error rate in M_{E-3,2}.

Assuming that Eve's channel 131 is noisier than Bob's channel 121, this three-stage system may be tuned to guarantee practical physical-layer secrecy. As described herein, such tuning may include but is not limited to selection of functions and parameters for stage one, stage two, and/or stage three. In general, the objectives in such tuning comprise: (1) at stage three, provide a level of error correction that is sufficient to correct the errors in M_{B} but insufficient to correct the errors in M_{E} and (2) provide a combination of stage-two error propagation and stage-one secrecy to guarantee a theoretical target probability threshold that each output message word M_{E-3,2,1} is equivalent to random noise, or has a desired level of noise. The first objective may be achieved based on assumptions about the noise characteristics of Bob's channel 121 and the noise characteristics of Eve's channel 131, and/or based on information received from Bob 120 or otherwise obtained about the noise characteristics of Bob's channel 121, or by information obtained about the noise characteristics of Eve's channel 131.

Because many common communication environments share similar or virtually identical noise characteristics, it is not a merely academic exercise to attempt theoretic secrecy based on assumptions about the noise characteristics of Bob's channel 121 and assumptions about the noise characteristics of Eve's channel 131. For example, several common scenarios may allow for sufficiently accurate assumptions about noise characteristics for relevant channels. One such scenario is a home wireless router 110. For this scenario, assumptions may be made regarding Bob 120's likely distance to and signal access to the router, as well as Eve 130's likely distance to and signal access to the router 110. Other situations and circumstances may also be amenable to making sufficiently accurate assumptions about noise characteristics.

Using this three-stage approach to physical-layer security may result in practical information-theoretic security: the message received by the intended recipient is completely correct (no errors), but the message received by the eavesdropper is noise.

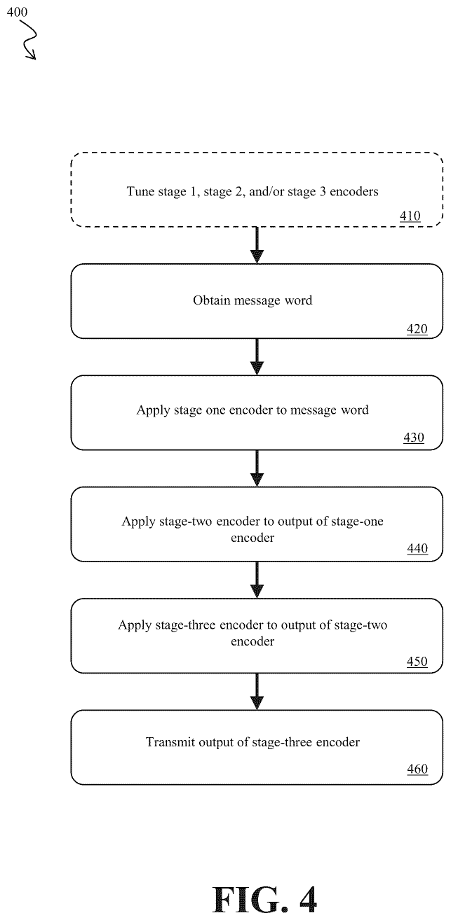

FIG. 4 shows a flowchart 400 illustrating an exemplary method for Alice to encode and transmit a message using the three-stage approach for physical layer security disclosed herein. At step 410, Alice optionally selects, tunes, and/or modifies the stage-one encoder, stage-two encoder, and/or stage-three encoder. At step 420, Alice obtains a message word. At step 430, Alice applies the stage-one encoder to the message word. At step 440, Alice applies the stage-two encoder to the output of the stage-one encoder. At step 450, Alice applies the stage-three encoder to the output of the stage-two encoder. At step 460, Alice transmits the output of the stage-three encoder.

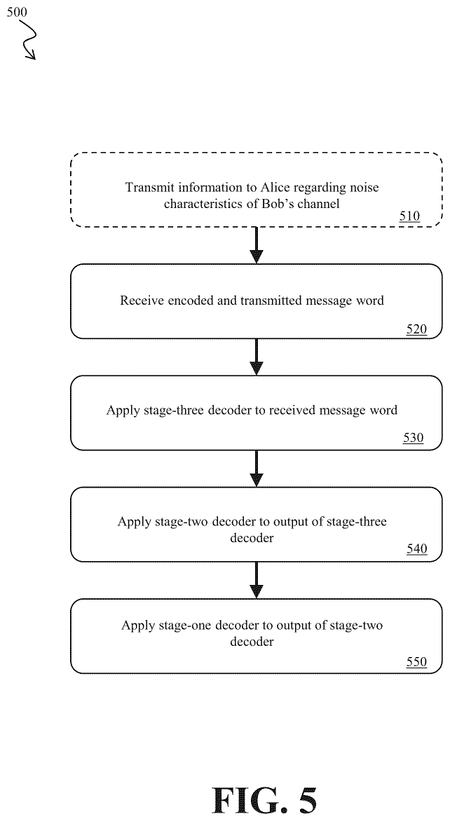

FIG. 5 shows a flowchart 500 illustrating an exemplary method for Bob to receive an encoded message word that has been transmitted from Alice using the three-stage approach for physical layer security disclosed herein. At step 510 Bob optionally transmits information to Alice regarding the noise characteristics of Bob's channel. At step 520, Bob receives a message word that has been encoded by Alice and transmitted from Alice. At step 530, Bob applies the stage-three decoder to the message word received from Alice. At step 540, Bob applies the stage-two decoder to the output of the stage-three decoder. At step 550, Bob applies the stage-one decoder to the output of the stage-two decoder.

### Polar Code Security

In another embodiment, physical layer security and/or secrecy may be achieved by using a secret key to populate frozen (in the sense of polar coding) bit locations in a polar encoding.

As is well known in the art, polar encoders are linear block encoders in which the encoding process comprises multiplying a vector V by a generator matrix G. The polar encoder generates the vector V by interleaving (or multiplexing) frozen bits (explained below) with bits from a message word M. The frozen bits are carefully assigned to locations in V that will allow a successive cancellation decoder tuned to the channel to remove all errors from the received word.

Successive cancellation decoders have a well-known polar coding property, i.e., a phenomenon in which, over multiple message words transmitted over time, each bit location in the corresponding received message words polarizes: It is either correct over all received message words (i.e., correct in ˜100% of received message words), or it is arbitrary noise over all received message words (i.e., incorrect in ˜50% of received message words and therefore conveys no information). Because successive cancellation has this polar coding property, errors in the successive cancellation decoding process tend to accumulate only at specific frozen bit locations, and hence can be completely removed if the values of these bit locations are known by both the sender and recipient. This shared knowledge of the values of the frozen bit locations can be accomplished by “freezing” the bit locations where errors occur, i.e., agreeing between the sender and recipient that the frozen bit locations will not be used to transmit information. Because successive cancellation relies upon the correctness of each previously decoded bit, the sender and recipient may agree that, for purposes of successive cancellation, the frozen bit locations will be treated as having a predetermined (or otherwise known) value. In many implementations, the value “0” is used by default for all frozen bit locations. Any other values could be used for the frozen bit locations as long as the sender and recipient both know (or can both determine) the values.

The generator matrix G may be produced by successive Kronecker powers of the base matrix

$$\\ F = [ \begin{matrix}1 & 0 \\ 1 & 1\end{matrix} ]$$

until the result is a square matrix with both dimensions equal to the length of V. With this construction, the length of V must be a power of 2. The resulting encoding, V×G→M_{V}, is then transmitted to a recipient, which receives M_{R} (M_{V} as received by the recipient on the recipient's channel). The recipient applies a successive cancellation decoder to M_{R}, resulting in M_{R-SCD}. The successive cancellation decoder operates sequentially on the symbols (bits) in M_{R}, and applies the known value of the frozen bits where appropriate according to the known locations of the frozen bits in V.

Assuming no transmission errors, i.e., assuming that M_{V}=M_{R}, then M_{R-SCD}=V, and M can be recovered by removing the multiplexed or interleaved frozen bits from V.

The approach disclosed herein assumes that Alice (sender), Bob (intended recipient), and Eve (eavesdropper) all know the bit locations in a message word that will be used for transmission of information, and also know that the remaining bit locations (the non-information bit locations) will be frozen, i.e., not used for transmission of information, but set to an agreed-upon value.

In one embodiment, instead of populating the frozen bit locations with a value known to Alice, Bob, and Eve, Alice populates the frozen bit locations with values that are known to Alice and Bob—but not to Eve. For example, a secret key shared between Alice and Bob may be used to seed a random-number generator or pseudo-random-number generator, which may be used to generate values for the frozen bit locations. Many ways and schemes are known in the art for Alice and Bob to share a secret key or other secret information. This embodiment is independent of the particular secret key sharing algorithm in use.

Because Eve does not know the values that Alice used for the frozen bits in the encoding, Eve is unable to correctly decode the received message word using the successive cancellation decoder. The effectiveness of this approach does not depend solely on relative noise levels or relative bit error rates between Bob's channel and Eve's channel, and therefore does not depend solely on Bob's channel being less noisy than Eve's channel. This approach is made more effective however, i.e., ensuring that Bob receives Alice's message and Eve receives noise, as Bob's channel advantage over Eve increases.

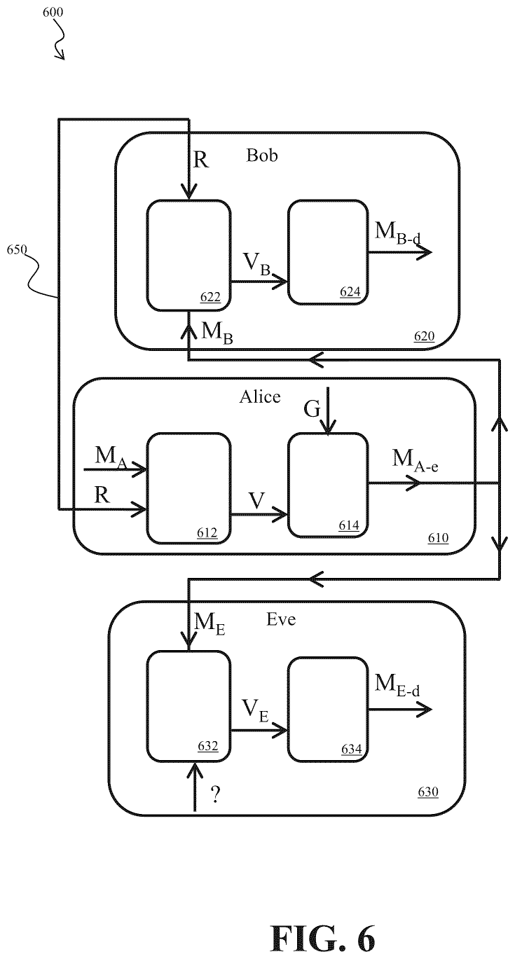

FIG. 6 shows a conceptual view of an exemplary system 600 for implementing polar coding security as disclosed herein. As shown in FIG. 6, Alice may be a WiFi router 610, Bob may be a laptop 620, and Eve may be an eavesdropper 630. Alice may comprise a module 612 for generating V as described above, i.e., by interleaving message word M_{A} (the message word that Alice desires to transmit to Bob) with random frozen values R. Alice may additionally comprise a module 614 for taking V as input, multiplying V by generator matrix G, and outputting M_{A-e} (Alice's original message, M_{A}, encoded by module 612 and module 614).

Bob may comprise a module 622 for applying a successive cancellation decoder to random frozen values R and to M_{B} (transmitted message as received by Bob), and may additionally comprise a module 624 for extracting a message word M_{B-d} from the output of applying the successive cancellation decoder 622.

Eve may comprise a module 632 for applying a successive cancellation decoder to M_{E} (transmitted message as received by Eve), and may additionally comprise a module 634 for extracting a message word M_{B}-e from the output of applying the successive cancellation decoder 632.

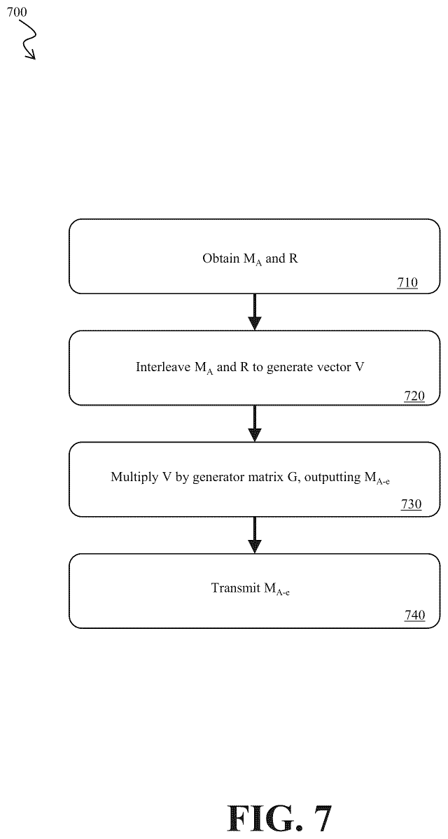

FIG. 7 shows a flowchart 700 for an exemplary method for Alice to use polar coding for secrecy as described herein. At step 710, Alice obtains a message M_{A} and a random number R. As described herein, Bob also knows R. R may be a shared secret. As is understood in the art, a shared secret key used to generate random or pseudo-random values R. Many schemes may be used for sharing a secret between Alice and Bob and then for using that shared secret to generate a value R.

At step 720, Alice uses module 612 to interleave M_{A} and R to generate vector V. At step 730, Alice uses module 614 to multiply vector V by generator matrix G, outputting M_{A-e}. At step 740, Alice transmits M_{A-e}.

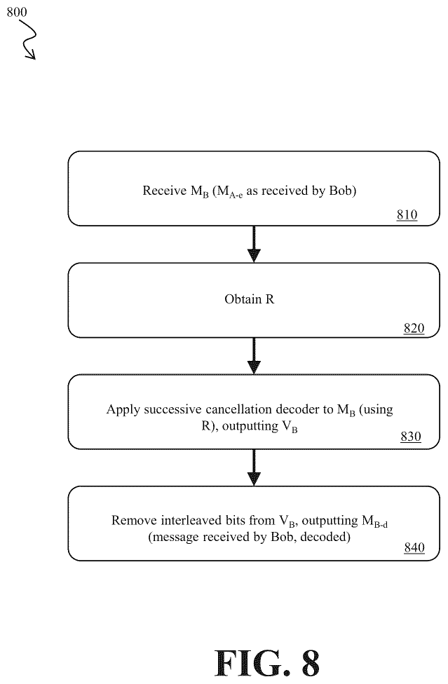

FIG. 8 shows a flowchart 800 for an exemplary method for Bob to use polar coding for secrecy as described herein. At step 810, Bob receives M_{B}, which is the message transmitted by Alice as received by Bob on Bob's channel. At step 820, Bob obtains R. As described herein above, R is a secret that is shared between Alice and Bob. At step 830, Bob applies the successive cancellation decoder (using R) in module 622 to M_{B}, outputting V_{B}. At step 840, Bob applies module 624 to remove the interleaved bits from V_{B}, outputting M_{B}-d (message M_{B} as received by Bob, decoded). Because Alice and Bob have a shared secret and are therefore able to use the same values for the frozen bits, Bob's application of module 622 results in an errorless V_{B} (or having errors that do not exceed some known or acceptable threshold), i.e., V_{B}=V. Because V_{B}=V, when Bob's module 624 removes the interleaved frozen bits from V_{B}, the output M_{B-d} is errorless, i.e., M_{B-d}=M_{A}.

On the other hand, Eve's module 632 fails because Eve does not know R. V_{E} (the output of Eve's module 632) is not errorless and V_{E}≠V. Because V_{E}≠V, Eve's module 634, which removes the interleaved frozen bits, is unable to correct these errors, and M_{E-d}≠M_{A}. M_{E-d} does not just have errors, but, as an artifact of successive cancellation, M_{E-d} is noise.

The computer algorithms, methods, and systems disclosed and described herein may be implemented in software, hardware, a combination of both, or any other means or technology known in the art.

As used herein, the term computer includes any device comprising a processor and configured to execute computer-executable instructions. A computer may further include hardware and/or software for data transmission, e.g., USB port, a radio frequency antenna, an ethernet port, or any of the many other known data transmission methods or technologies known in the art.

What is claimed is:

1. A method for a computer to provide physical-layer security in data transmission, comprising:
obtaining a pattern of frozen bit locations;
obtaining a message word;
applying the pattern of frozen bit locations to the message word to generate a frozen-modified message word having both message word bit locations and frozen bit locations;
multiplying the frozen-modified message word by a generator matrix G to generate a frozen-encoded word; and
transmitting the frozen-encoded word on a data transmission medium.

2. The method of claim 1, further comprising sharing, with an intended recipient, the pattern of frozen bit locations.

3. The method of claim 1, further comprising publicizing a successive cancellation decoder.

4. The method of claim 1, wherein applying the pattern of frozen bit locations comprises assigning a randomly generated value to one or more of the frozen bit locations.

5. The method of claim 1, wherein the pattern of frozen bit locations is configured to allow a successive cancellation decoder tuned to a transmission channel to remove a level of errors from the received word.

6. The method of claim 1, wherein the generator matrix G is a square matrix with both dimensions equal to the length of the frozen-modified message word.

7. The method of claim 1, wherein:
a transmission channel with a desired recipient is less noisy than a transmission channel with an undesired recipient; and
the generator matrix G is tuned based on at least one from the following: (i) the transmission channel with the desired recipient and (ii) the transmission channel with the undesired recipient.

8. The method of claim 1, further comprising secretively sharing the pattern of frozen bit locations with a desired recipient.

9. The method of claim 1, further comprising:
secretively sharing with a desired recipient a seed for setting bit values or at least one of the frozen bit locations; and
using that seed to set bit values at frozen bit locations.

10. A method for a computer to provide physical-layer security in data transmission, comprising:
obtaining a pattern of frozen bit locations;
receiving a received message word;
applying a successive cancellation decoder to the received message word to generate a successive-cancellation-decoded message word;
applying the pattern of frozen bit locations to remove the frozen bits from the successive-cancellation-decoded message word to generate a decoded message word.
